(19) United States
(12) Patent Application Publication
(10) Pub. No.: US 2020/0187113 A1
(43) Pub. Date: Jun. 11, 2020

(54) ENERGY SAVINGS IN RADIO NETWORKS

(71) Applicant: NOKIA SOLUTIONS AND NETWORKS OY, Espoo (FI)

(72) Inventors: Stephen MWANJE, Dorfen (DE); Janne Tapio ALI-TOLPPA, Taufkirchen (DE)

(73) Assignee: NOKIA SOLUTIONS AND NETWORKS OY, Espoo (FI)

(21) Appl. No.: 16/316,091

(22) PCT Filed: Jul. 8, 2016
(86) PCT No.: PCT/EP2016/059396

§ 371 Date: Jan. 8, 2019

(51) Int. Cl. H04W 52/02; H04W 28/08; H04W 28/02

(52) U.S. Cl. CPC H04W 52/0206; H04W 28/0257; H04W 28/0221; H04W 28/08

(57) ABSTRACT

It is provided a method, comprising detecting a trigger; estimating, for each of one or more deactivated helper cells, a respective estimated transferred load if the trigger is detected, wherein the respective estimated transferred load will be transferred from a reference cell to the respective helper cell if the respective helper cell will be activated, and the one or more deactivated helper cells belong to a power saving group consisting of the reference cell and one or more helper cells; determining determine a candidate cell among the deactivated helper cells, wherein the estimated transferred load of the candidate cell is maximum among the estimated transferred loads; instructing activating of the candidate cell.

### FIELD OF THE INVENTION

The present invention relates to an apparatus, a method, and a computer program product related to energy savings in radio networks. More particularly, the present invention relates to an apparatus, a method, and a computer program product related to energy savings in heterogeneous networks.

### ABBREVIATIONS

3G, 4G, 5G 3^{rd}, 4^{th}, 5^{th} generation

3GPP 3^{rd} Generation Partnership Project

B6G Below 6 GHz

BS Base Station

CM Configuration Management

C-RAN Centralized Radio Access Network

eNB evolved NodeB

ES Energy Saving

ESM Energy Saving Management

FCE Fluid Capacity Engine

Hetnets heterogeneous networks

LOS Line of Sight

LTE Long Term Evolution

LTE-A LTE-Advanced

NM Network Management

NR Neighbor Relation(ship)

OAM Operations, Administration and Management

PSG Power Saving Group

RAN Radio Access Network

RAT Radio Access Technology

RRH Remote Radio Head

ThH Threshold (High)

ThL Threshold (Low)

UE User Equipment

### BACKGROUND OF THE INVENTION

Heterogeneous networks (e.g. 5G networks of 3GPP) are characterized by:
1. Cells deployed in multiple network layers or radio layers: network layers with at least 1 macro layer and 1 independent small cell/pico layer or radio layers with multiple radio interfaces (B6G, cm wave and/or mm wave) in a single eNB.
2. The pico cells' coverage being substantially or even completely overlaid by the macro cells' coverage, i.e. macro cells provide complete coverage such that pica cells only complement the capacity but do not add substantially to the coverage.
3. Macro cells and pico cells could be of different technologies, e.g. respectively 3G, LTE/A or new 5G radios.

The current demand for higher mobile throughput (which is typically expected to increase) requires that each of these multiple network/radio layers will get denser. This results in increased energy consumption for which solutions are needed to reduce that consumption.

In any network, traffic varies throughout the day [1,2] with a typical profile as shown in FIG. 1. On the other hand, networks have historically been provisioned for peak traffic. This results into excessive unneeded capacity during off peak times which are accompanied by unnecessary energy consumption by the base stations (BS). With the radio network consuming up to 90% of the network energy [3], significant savings can be made if unneeded BS are deactivated. This is also the case even if only the power amplifier is switched off, given its consumption of up to 50% to 65% [2].

For energy saving in a multi-layer network, three problems should be solved:
1) When the load in a set of cells reduces and the ESM solution needs to deactivate some cells, how are those deactivation candidate cells selected? The simplistic approach is to select the cell(s) with least traffic. The challenge here is that traffic typically reduces slowly in all cells. No single cell gets such low traffic compared to others that it can be easily deactivated. In effect waiting for one cell to reduce so low implies waiting for all cells to be that low.
2) Related to 1 above is that even though it is clear that the macro network is able to fill coverage, it should be confirmed that it also has the capacity to take up that traffic. This means that the decision must consider traffic in the macro network, i.e. ESM should select the deactivation candidate such that the traffic in other cells (including macro cells) does not rise so high that it causes overload in those cells
3) When load in a set of active cells increases beyond some threshold, ESM needs to reactivate some cells. The question here is how does it select the cell to activate if multiple cells are inactive? The simplest solution is to activate all inactive cells which is very inefficient since unneeded capacity will again be provisioned. Alternative simple approaches that have received significant attention include activating cells based on a fixed time sequence or using historical data of the sequence that has been used before. Although these are better than the first approach they are also inefficient.

Original ideas on ESM considered cell de- and re-activation among single layer networks with solutions focusing on how to compensate for lost coverage [4].

Initial ESM solutions for Hetnets considered ES among co-located cells and with overlapping coverage [5,6]. Therein the ES solution always evaluates if traffic in one cell has reduced sufficiently that the cell can be deactivated. And when traffic in the active cell increases, the inactive cell is reactivated. An example is undertaking ES between two overlapping cells with one at 900 MHz and the second at 1800 MHz. During low traffic, the 1800 MHz (less coverage cell) is deactivated and reactivated when traffic increases in the 900 MHz cell. Note that this will not always be the case for 5G where ES may need to be undertaken among cells from different network layers. A network-wide/centralized solution may be employed in that case.

Similar to the method for selecting deactivation candidates, reactivation candidates were proposed to be selected as the inactive cells collocated with the high traffic cell. This is again not applicable in 5G Hetnets.

An alternative approach (see FIG. 1) considers that when extra capacity is needed, all available cells should be activated. Cells are then monitored and if the usage of one cell goes down, that cell is deactivated. However, as stated earlier, traffic typically does not reduce independently in each cell when averaged over times (e.g. 5 min, 15 min, 1 hour) typically considered for configuration tasks like activation and deactivation of cells. It typically gradually reduces in all cells. This is mostly so because traffic management policies keep users in the small cells where the spectral efficiency is better. As such, small cell traffic may never reduce below that of macro cells and it may not be possible to identify even a single small cell which can be deactivated.

A derivative solution/algorithm applies a fixed schedule which is followed all the time. Such a schedule is either deduced from the pattern in the first approach above or is set by a human operator according to his understanding of the traffic variations. These fixed schedules are however inaccurate and are either likely to remain energy inefficient or will cause service degradation.

In all the best deactivation/reactivation decision should be based on the global traffic in the area and should, as shown in FIG. 2, track the temporal (and spatial) variation of the demand. To this effect there has been a proposal for power saving groups—cell group that covers a given area and among which cells can be deactivated when there is low demand.

### REFERENCES

[1] O. Blume, H. Eckhardt, S. Klein, E. Kuehn, W M. Wajda, “Energy Savings in Mobile Networks Based on Adaptation to Traffic Statistics”, Bell Labs Technical Journal, 2010
[2] Gilbert Micallef, Louai Saker and Salah E. Elayoubi, Hans-Otto Scheck, “Realistic Energy Saving Potential of Sleep Mode for Existing and Future Mobile Networks” JOURNAL OF COMMUNICATIONS, VOL. 7, NO. 10, OCTOBER 2012
[3] R. Dilupa, R. Withanage, D. Arunatileka. “Infrastructure Sharing & Renewable Energy Use In Telecommunication Industry for Sustainable Development.” Handbook of Research on Green ICT: Technology, Business and Social Perspectives. IGI Global, 2011.
[4] Jianmin Fang, “Method, apparatus and system for realizing coverage compensation”, Zte Corporation WO2014110910 Al/CN103945506A
[5] Elena Voltolina, Tarmo Kuningas “Energy-saving mechanisms in a heterogeneous radio communication network” Ericsson WO2011021975 A1/U.S. Pat. No. 12,790,055
[6] Karl Heinz Nenner, Dieter Jacobsohn, Heinz Polsterer “Method for saving energy in operating a first and second mobile communication networks, a mobile communication networks” Deutsche Telekom A G, T-Mobile International Austria GmbH EP2676491 A1/US20130344863.

### SUMMARY OF THE INVENTION

It is an object of the present invention to improve the prior art.

According to a first aspect of the invention, there is provided an apparatus, comprising trigger detecting means adapted to detect a trigger; load transfer estimating means adapted to estimate, for each of one or more deactivated helper cells, a respective estimated transferred load if the trigger is detected, wherein the respective estimated transferred load will be transferred from a reference cell to the respective helper cell if the respective helper cell will be activated, and the one or more deactivated helper cells belong to a power saving group consisting of the reference cell and one or more helper cells; candidate determining means adapted to determine a candidate cell among the deactivated helper cells, wherein the estimated transferred load of the candidate cell is maximum among the estimated transferred loads; instructing means adapted to instruct activating of the candidate cell.

The trigger may comprise at least one of the following: lapse of a predetermined time period; a combined load is higher than a predefined upper combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and a minimum load of the loads of the activated helper cells of the power saving group is larger than a predefined lower minimum threshold.

The trigger may comprise that the combined load is higher than the predefined upper combined load threshold and the predefined weights for all of the helper cells may be 0.

For each of the deactivated helper cells, the estimated transferred load from the reference cell j to the respective deactivated helper cell i upon activation of the helper cell i may be calculated according to a following formula:

$${h}_{ij} = \{ \begin{matrix}{ρ}_{j} \cdot {[ \frac{{d}_{ij}}{cos ( {α}^{τ} )} ]}^{r} & , \frac{{d}_{ij}}{cos ( {α}^{τ} )} < {R}_{j} \\ {ρ}_{j} \cdot {[ \frac{{d}_{ij}}{cos ( {α}^{τ} )} ]}^{r} \cdot [ 1 - {[ \frac{\frac{{d}_{ij}}{cos ( {α}^{τ} )} - {R}_{j}}{{R}_{j}} ]}^{1 \text{/} r} ] & , \frac{{d}_{ij}}{cos ( {α}^{τ} )} > {R}_{j}\end{matrix} ,$$

wherein ρⱼ is a load of the reference cell j; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on a beam width of an antenna of the reference cell j.

The load transfer estimating means may be further adapted to estimate, for each deactivated cell of plural power saving groups, a respective estimated transferred load per power saving group of the plural power saving groups, wherein each of the plural power saving groups is predefined, consists of a respective reference cell and respective one or more helper cells, and for all of the plural power saving groups the reference cells are different from each other; and the apparatus may further comprise adding means adapted to add, for each of the deactivated cells of the plural power saving groups, the respective estimated transferred loads per power saving group in order to obtain a total estimated transferred load for the respective deactivated cell; wherein the candidate determining means may be adapted to determine the candidate cell such that the total estimated transferred load of the candidate cell is maximum among the total estimated transferred loads.

According to a second aspect of the invention, there is provided an apparatus, comprising trigger detecting means adapted to detect a trigger; identifying means adapted to identify a candidate cell if the trigger is detected; instructing means adapted to instruct activating of the candidate cell; wherein the trigger comprises at least one of a combined load is higher than a predefined upper combined load threshold, wherein the combined load is obtained by summing respective weighted loads of a reference cell associated to a power saving group and activated helper cells of the power saving group, each of the weighted loads is obtained by multiplying a load of the respective one of the reference cell and the activated helper cells with a respective predefined weight, and respective weights for at least two of the cells of the power saving group are larger than 0; and a minimum of loads of activated helper cells of the power saving group is larger than a predefined lower minimum threshold.

The identifying means may comprise latest activated helper cell determining means adapted to identify a last activated helper cell in a predefined sequence of helper cells of the power saving group, wherein all helper cells following the last activated helper cell in the predefined sequence are deactivated; determining means adapted to determine, as the candidate cell, a next helper cell following the last activated helper cell in the predefined sequence.

According to a third aspect of the invention, there is provided an apparatus, comprising trigger detecting means adapted to detect a trigger; load transfer estimating means adapted to estimate, for each of one or more activated helper cells, a respective estimated transferred load if the trigger is detected, wherein the respective estimated transferred load will be transferred to a reference cell from the respective helper cell if the respective helper cell will be deactivated, and the one or more activated helper cells belong to a power saving group consisting of the reference cell and one or more helper cells; candidate determining means adapted to determine a candidate cell among the activated helper cells, wherein the estimated transferred load of the candidate cell is minimum among the estimated transferred loads; instructing means adapted to instruct deactivating of the candidate cell.

The trigger may comprise at least one of the following: lapse of a predetermined time period; a combined load is lower than a predefined lower combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and a maximum load of the loads of the activated helper cells of the power saving group is smaller than a predefined upper maximum threshold.

The trigger may comprise that the combined load is lower than the predefined lower combined load threshold and the predefined weights for all of the helper cells may be 0.

For each of the activated helper cells, the estimated transferred load to the reference cell j from the respective activated helper cell i upon deactivation of the helper cell i may be calculated according to a following formula:

$${h}_{ji} = \{ \begin{matrix}{ρ}_{i} \cdot {[ \frac{{d}_{ij}}{{cos}^{τ} ( α )} ]}^{r} & , \frac{{d}_{ij}}{{cos}^{τ} ( α )} < {R}_{j} \\ {ρ}_{i} \cdot {[ \frac{{d}_{ij}}{{cos}^{τ} ( α )} ]}^{r} \cdot [ 1 - {[ \frac{\frac{{d}_{ij}}{{cos}^{τ} ( α )} - {R}_{j}}{{R}_{j}} ]}^{1 \text{/} r} ] & , \frac{{d}_{ij}}{{cos}^{τ} ( α )} > {R}_{j}\end{matrix} ,$$

wherein ρᵢ is a load of the helper cell i; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on beam width of an antenna of the reference cell j.

The load transfer estimating means may be further adapted to estimate, for each activated cell of plural power saving groups, a respective estimated transferred load per power saving group of the plural power saving groups, wherein each of the plural power saving groups is predefined, consists of a respective reference cell and respective one or more helper cells, and for all of the plural power saving groups the reference cells are different from each other; and the apparatus may further comprise adding means adapted to add, for each of the activated cells of the plural power saving groups, the respective estimated transferred loads per power saving group in order to obtain a total estimated transferred load for the respective activated cell; wherein the candidate determining means may be adapted to determine the candidate cell such that the total estimated transferred load of the candidate cell is minimum among the total estimated transferred loads.

According to a fourth aspect of the invention, there is provided an apparatus, comprising trigger detecting means adapted to detect a trigger; identifying means adapted to identify a candidate cell if the trigger is detected; instructing means adapted to instruct deactivating of the candidate cell; wherein the trigger comprises at least one of a combined load is lower than a predefined lower combined load threshold, wherein the combined load is obtained by summing respective weighted loads of a reference cell associated to a power saving group and activated helper cells of the power saving group, each of the weighted loads is obtained by multiplying a load of the respective one of the reference cell and the activated helper cells with a respective predefined weight, and respective weights for at least two of the cells of the power saving group are larger than 0; and a maximum of loads of the activated helper cells of the power saving group is smaller than a predefined upper maximum threshold.

The identifying means may be adapted to identify the candidate cell as a last activated helper cell in a predefined sequence of the helper cells of the power saving group, wherein all helper cells following the last activated helper cell in the predefined sequence are deactivated.

According to a fifth aspect of the invention, there is provided an apparatus, comprising trigger detecting circuitry configured to detect a trigger; load transfer estimating circuitry configured to estimate, for each of one or more deactivated helper cells, a respective estimated transferred load if the trigger is detected, wherein the respective estimated transferred load will be transferred from a reference cell to the respective helper cell if the respective helper cell will be activated, and the one or more deactivated helper cells belong to a power saving group consisting of the reference cell and one or more helper cells; candidate determining circuitry configured to determine a candidate cell among the deactivated helper cells, wherein the estimated transferred load of the candidate cell is maximum among the estimated transferred loads; instructing circuitry configured to instruct activating of the candidate cell.

The trigger may comprise at least one of the following: lapse of a predetermined time period; a combined load is higher than a predefined upper combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and a minimum load of the loads of the activated helper cells of the power saving group is larger than a predefined lower minimum threshold.

The trigger may comprise that the combined load is higher than the predefined upper combined load threshold and the predefined weights for all of the helper cells may be 0.

For each of the deactivated helper cells, the estimated transferred load from the reference cell j to the respective deactivated helper cell i upon activation of the helper cell i may be calculated according to a following formula:

$${h}_{ij} = \{ \begin{matrix}{ρ}_{j} \cdot {[ \frac{{d}_{ij}}{cos ( {α}^{τ} )} ]}^{r} & , \frac{{d}_{ij}}{cos ( {α}^{τ} )} < {R}_{j} \\ {ρ}_{j} \cdot {[ \frac{{d}_{ij}}{cos ( {α}^{τ} )} ]}^{r} \cdot [ 1 - {[ \frac{\frac{{d}_{ij}}{cos ( {α}^{τ} )} - {R}_{j}}{{R}_{j}} ]}^{1 \text{/} r} ] & , \frac{{d}_{ij}}{cos ( {α}^{τ} )} > {R}_{j}\end{matrix} ,$$

wherein ρⱼ is a load of the reference cell j; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on a beam width of an antenna of the reference cell j.

The load transfer estimating circuitry may be further configured to estimate, for each deactivated cell of plural power saving groups, a respective estimated transferred load per power saving group of the plural power saving groups, wherein each of the plural power saving groups is predefined, consists of a respective reference cell and respective one or more helper cells, and for all of the plural power saving groups the reference cells are different from each other; and the apparatus may further comprise adding circuitry configured to add, for each of the deactivated cells of the plural power saving groups, the respective estimated transferred loads per power saving group in order to obtain a total estimated transferred load for the respective deactivated cell; wherein the candidate determining circuitry may be configured to determine the candidate cell such that the total estimated transferred load of the candidate cell is maximum among the total estimated transferred loads.

According to a sixth aspect of the invention, there is provided an apparatus, comprising trigger detecting circuitry configured to detect a trigger; identifying circuitry configured to identify a candidate cell if the trigger is detected; instructing circuitry configured to instruct activating of the candidate cell; wherein the trigger comprises at least one of a combined load is higher than a predefined upper combined load threshold, wherein the combined load is obtained by summing respective weighted loads of a reference cell associated to a power saving group and activated helper cells of the power saving group, each of the weighted loads is obtained by multiplying a load of the respective one of the reference cell and the activated helper cells with a respective predefined weight, and respective weights for at least two of the cells of the power saving group are larger than 0; and a minimum of loads of activated helper cells of the power saving group is larger than a predefined lower minimum threshold.

The identifying circuitry may comprise latest activated helper cell determining circuitry configured to identify a last activated helper cell in a predefined sequence of helper cells of the power saving group, wherein all helper cells following the last activated helper cell in the predefined sequence are deactivated; determining circuitry configured to determine, as the candidate cell, a next helper cell following the last activated helper cell in the predefined sequence.

According to a seventh aspect of the invention, there is provided an apparatus, comprising trigger detecting circuitry configured to detect a trigger; load transfer estimating circuitry configured to estimate, for each of one or more activated helper cells, a respective estimated transferred load if the trigger is detected, wherein the respective estimated transferred load will be transferred to a reference cell from the respective helper cell if the respective helper cell will be deactivated, and the one or more activated helper cells belong to a power saving group consisting of the reference cell and one or more helper cells; candidate determining circuitry configured to determine a candidate cell among the activated helper cells, wherein the estimated transferred load of the candidate cell is minimum among the estimated transferred loads; instructing circuitry configured to instruct deactivating of the candidate cell. The trigger may comprise at least one of the following: lapse of a predetermined time period; a combined load is lower than a predefined lower combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and a maximum load of the loads of the activated helper cells of the power saving group is smaller than a predefined upper maximum threshold.

The trigger may comprise that the combined load is lower than the predefined lower combined load threshold and the predefined weights for all of the helper cells may be 0.

For each of the activated helper cells, the estimated transferred load to the reference cell j from the respective activated helper cell i upon deactivation of the helper cell i may be calculated according to a following formula:

$${h}_{ji} = \{ \begin{matrix}{ρ}_{i} \cdot {[ \frac{{d}_{ij}}{{cos}^{τ} ( α )} ]}^{r} & , \frac{{d}_{ij}}{{cos}^{τ} ( α )} < {R}_{j} \\ {ρ}_{i} \cdot {[ \frac{{d}_{ij}}{{cos}^{τ} ( α )} ]}^{r} \cdot [ 1 - {[ \frac{\frac{{d}_{ij}}{{cos}^{τ} ( α )} - {R}_{j}}{{R}_{j}} ]}^{1 \text{/} r} ] & , \frac{{d}_{ij}}{{cos}^{τ} ( α )} > {R}_{j}\end{matrix} ,$$

wherein ρᵢ is a load of the helper cell i; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on beam width of an antenna of the reference cell j.

The load transfer estimating circuitry may be further configured to estimate, for each activated cell of plural power saving groups, a respective estimated transferred load per power saving group of the plural power saving groups, wherein each of the plural power saving groups is predefined, consists of a respective reference cell and respective one or more helper cells, and for all of the plural power saving groups the reference cells are different from each other; and the apparatus may further comprise adding circuitry configured to add, for each of the activated cells of the plural power saving groups, the respective estimated transferred loads per power saving group in order to obtain a total estimated transferred load for the respective activated cell; wherein the candidate determining circuitry may be configured to determine the candidate cell such that the total estimated transferred load of the candidate cell is minimum among the total estimated transferred loads.

According to an eighth aspect of the invention, there is provided an apparatus, comprising trigger detecting circuitry configured to detect a trigger; identifying circuitry configured to identify a candidate cell if the trigger is detected; instructing circuitry configured to instruct deactivating of the candidate cell; wherein the trigger comprises at least one of a combined load is lower than a predefined lower combined load threshold, wherein the combined load is obtained by summing respective weighted loads of a reference cell associated to a power saving group and activated helper cells of the power saving group, each of the weighted loads is obtained by multiplying a load of the respective one of the reference cell and the activated helper cells with a respective predefined weight, and respective weights for at least two of the cells of the power saving group are larger than 0; and a maximum of loads of the activated helper cells of the power saving group is smaller than a predefined upper maximum threshold.

The identifying circuitry may be configured to identify the candidate cell as a last activated helper cell in a predefined sequence of the helper cells of the power saving group, wherein all helper cells following the last activated helper cell in the predefined sequence are deactivated.

According to a ninth aspect of the invention, there is provided a method, comprising detecting a trigger; estimating, for each of one or more deactivated helper cells, a respective estimated transferred load if the trigger is detected, wherein the respective estimated transferred load will be transferred from a reference cell to the respective helper cell if the respective helper cell will be activated, and the one or more deactivated helper cells belong to a power saving group consisting of the reference cell and one or more helper cells; determining determine a candidate cell among the deactivated helper cells, wherein the estimated transferred load of the candidate cell is maximum among the estimated transferred loads; instructing activating of the candidate cell.

The trigger may comprise at least one of the following: lapse of a predetermined time period; a combined load is higher than a predefined upper combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and a minimum load of the loads of the activated helper cells of the power saving group is larger than a predefined lower minimum threshold.

The trigger may comprise that the combined load is higher than the predefined upper combined load threshold and the predefined weights for all of the helper cells may be 0.

For each of the deactivated helper cells, the estimated transferred load from the reference cell j to the respective deactivated helper cell i upon activation of the helper cell i may be calculated according to a following formula:

$${h}_{ij} = \{ \begin{matrix}{ρ}_{j} \cdot {[ \frac{{d}_{ij}}{cos ( {α}^{τ} )} ]}^{r} & , \frac{{d}_{ij}}{cos ( {α}^{τ} )} < {R}_{j} \\ {ρ}_{j} \cdot {[ \frac{{d}_{ij}}{cos ( {α}^{τ} )} ]}^{r} \cdot [ 1 - {[ \frac{\frac{{d}_{ij}}{cos ( {α}^{τ} )} - {R}_{j}}{{R}_{j}} ]}^{1 \text{/} r} ] & , \frac{{d}_{ij}}{cos ( {α}^{τ} )} > {R}_{j}\end{matrix} ,$$

wherein ρⱼ is a load of the reference cell j; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on a beam width of an antenna of the reference cell j.

The estimating of the transferred load may comprise estimating, for each deactivated cell of plural power saving groups, a respective estimated transferred load per power saving group of the plural power saving groups, wherein each of the plural power saving groups is predefined, consists of a respective reference cell and respective one or more helper cells, and for all of the plural power saving groups the reference cells are different from each other;

and the method may further comprise adding, for each of the deactivated cells of the plural power saving groups, the respective estimated transferred loads per power saving group in order to obtain a total estimated transferred load for the respective deactivated cell; wherein the candidate cell may be determined such that the total estimated transferred load of the candidate cell is maximum among the total estimated transferred loads.

According to a tenth aspect of the invention, there is provided a method, comprising detecting a trigger; identifying a candidate cell if the trigger is detected; instructing activating of the candidate cell; wherein the trigger comprises at least one of a combined load is higher than a predefined upper combined load threshold, wherein the combined load is obtained by summing respective weighted loads of a reference cell associated to a power saving group and activated helper cells of the power saving group, each of the weighted loads is obtained by multiplying a load of the respective one of the reference cell and the activated helper cells with a respective predefined weight, and respective weights for at least two of the cells of the power saving group are larger than 0; and a minimum of loads of activated helper cells of the power saving group is larger than a predefined lower minimum threshold.

The identifying may comprise identifying a last activated helper cell in a predefined sequence of helper cells of the power saving group, wherein all helper cells following the last activated helper cell in the predefined sequence are deactivated; determining, as the candidate cell, a next helper cell following the last activated helper cell in the predefined sequence.

According to an eleventh aspect of the invention, there is provided a method, comprising detecting a trigger; estimating, for each of one or more activated helper cells, a respective estimated transferred load if the trigger is detected, wherein the respective estimated transferred load will be transferred to a reference cell from the respective helper cell if the respective helper cell will be deactivated, and the one or more activated helper cells belong to a power saving group consisting of the reference cell and one or more helper cells;

determining a candidate cell among the activated helper cells, wherein the estimated transferred load of the candidate cell is minimum among the estimated transferred loads; instructing deactivating of the candidate cell.

The trigger may comprise at least one of the following: lapse of a predetermined time period; a combined load is lower than a predefined lower combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and a maximum load of the loads of the activated helper cells of the power saving group is smaller than a predefined upper maximum threshold.

The trigger may comprise that the combined load is lower than the predefined lower combined load threshold and the predefined weights for all of the helper cells may be 0.

For each of the activated helper cells, the estimated transferred load to the reference cell j from the respective activated helper cell i upon deactivation of the helper cell i may be calculated according to a following formula:

$${h}_{ji} = \{ \begin{matrix}{ρ}_{i} \cdot {[ \frac{{d}_{ij}}{{cos}^{τ} ( α )} ]}^{r} & , \frac{{d}_{ij}}{{cos}^{τ} ( α )} < {R}_{j} \\ {ρ}_{i} \cdot {[ \frac{{d}_{ij}}{{cos}^{τ} ( α )} ]}^{r} \cdot [ 1 - {[ \frac{\frac{{d}_{ij}}{{cos}^{τ} ( α )} - {R}_{j}}{{R}_{j}} ]}^{1 \text{/} r} ] & , \frac{{d}_{ij}}{{cos}^{τ} ( α )} > {R}_{j}\end{matrix} ,$$

wherein ρᵢ is a load of the helper cell i; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on beam width of an antenna of the reference cell j.

The estimating of the transferred load may comprise estimating, for each activated cell of plural power saving groups, a respective estimated transferred load per power saving group of the plural power saving groups, wherein each of the plural power saving groups is predefined, consists of a respective reference cell and respective one or more helper cells, and for all of the plural power saving groups the reference cells are different from each other; and the method may further comprise adding, for each of the activated cells of the plural power saving groups, the respective estimated transferred loads per power saving group in order to obtain a total estimated transferred load for the respective activated cell; wherein the candidate cell may be determined such that the total estimated transferred load of the candidate cell is minimum among the total estimated transferred loads.

According to a twelfth aspect of the invention, there is provided a method, comprising detecting a trigger; identifying a candidate cell if the trigger is detected; instructing deactivating of the candidate cell; wherein the trigger comprises at least one of a combined load is lower than a predefined lower combined load threshold, wherein the combined load is obtained by summing respective weighted loads of a reference cell associated to a power saving group and activated helper cells of the power saving group, each of the weighted loads is obtained by multiplying a load of the respective one of the reference cell and the activated helper cells with a respective predefined weight, and respective weights for at least two of the cells of the power saving group are larger than 0; and a maximum of loads of the activated helper cells of the power saving group is smaller than a predefined upper maximum threshold.

The identifying may comprise identifying the candidate cell as a last activated helper cell in a predefined sequence of the helper cells of the power saving group, wherein all helper cells following the last activated helper cell in the predefined sequence are deactivated.

Each of the methods according to the eighth to twelfth aspects may be a method of energy saving.

According to a thirteenth aspect of the invention, there is provided an apparatus comprising at least one processor and at least one memory including computer program code, and the at least one processor, with the at least one memory and the computer program code, being arranged to cause the apparatus to at least perform at least one of the methods according to the ninth to twelfth aspects.

According to a fourteenth aspect of the invention, there is provided a computer program product comprising a set of instructions which, when executed on an apparatus, is configured to cause the apparatus to carry out the method according to any of the ninth to twelfth aspects. The computer program product may be embodied as a computer-readable medium or directly loadable into a computer.

According to some example embodiments of the invention, at least one of the following technical effects may be provided:
Energy savings close to the optimum at a requested capacity may be achieved;
Applicability to both a small cell HetNet scenario (i.e. an overlay of large and small cells of the same RAT) or a multi-RAT HetNet scenario;
Dynamically allocating capacity to different physical locations within the radio coverage area;
May be employed as a Distributed SON (D-SON) solution in the Network Element (NE) or as a Centralized SON (C-SON) solution in the Network Management (NM) layer;
Signaling load may be reduced;
Solutions may be balanced between complexity for the calculation and amount of energy savings;

### BRIEF DESCRIPTION OF THE DRAWINGS

Further details, features, objects, and advantages are apparent from the following detailed description of example embodiments of the present invention which is to be taken in conjunction with the appended drawings, wherein

FIG. 1 illustrates demanded capacity, state of the art capacity provisioning, and desired capacity provisioning over a day;

FIG. 2 shows a FCE according to some example embodiments of the invention;

FIG. 3 illustrates the determination of cells as candidates for (de)activation using a single reference cell according to some example embodiments of the invention;

FIG. 4 illustrates the determination of cells as candidates for (de)activation using multiple reference cells according to some example embodiments of the invention;

FIG. 5 shows an apparatus according to an example embodiment of the invention;

FIG. 6 shows a method according to an example embodiment of the invention;

FIG. 7 shows an apparatus according to an example embodiment of the invention;

FIG. 8 shows a method according to an example embodiment of the invention;

FIG. 9 shows an apparatus according to an example embodiment of the invention;

FIG. 10 shows a method according to an example embodiment of the invention;

FIG. 11 shows an apparatus according to an example embodiment of the invention;

FIG. 12 shows a method according to an example embodiment of the invention; and

FIG. 13 shows an apparatus according to an example embodiment of the invention.

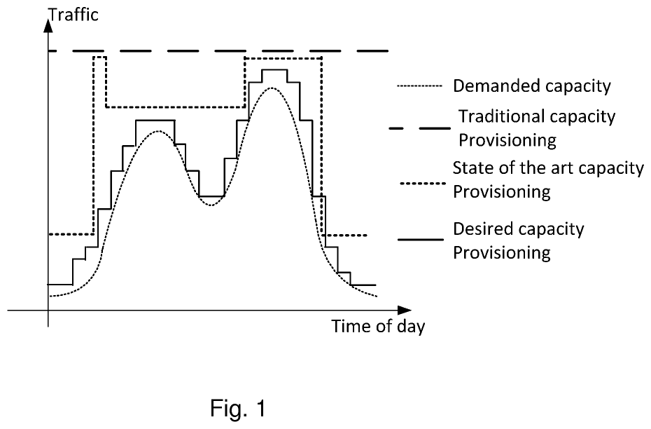

### DETAILED DESCRIPTION OF CERTAIN EXAMPLE EMBODIMENTS

Herein below, certain example embodiments of the present invention are described in detail with reference to the accompanying drawings, wherein the features of the example embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Some embodiments of the invention relate to Cognitive Network Management and specifically to the automated management of energy savings in heterogeneous networks, e.g. in 5G networks. Some embodiments of the invention are close to a best and most efficient approach for ESM by relying on the prevailing traffic in the network to decide the best candidate cells to (de)activate (i.e. to activate or deactivate, as the case may be).

Some embodiments of the invention employ power saving groups. The challenge when considering group load for cell (de)activation is that for a distributed solution, the need to discover the load at different cells significantly increases load related to signaling. Thus, embodiments of the invention use the advantage of group load but with reduced signaling.

Some embodiments of the invention address the above mentioned 3 sub- problems of the ES problem as follows:
1. Selection of Power Saving Groups (PSGs): First, cells are grouped in PSGs for energy saving management. Namely, some embodiments of the invention define two cells types—reference cells that have the load responsibility, and helper cells that assist the reference cells when needed i.e. which can be deactivated and reactivated as needed.
2. Characterization of PSG load: Some embodiments of the invention define a load to be used as a trigger for the cell activation and deactivation. Namely, the load in all the active cells of the PSG is considered in order to decide whether to activate more cells or deactivate some cells. Thus, cells may be deactivated when the traffic in a number of cells is low enough such that other cells may take over the traffic.
3. Deactivation/reactivation order (or “switch-on (-off)” order): Based on the observed load, one or more cells are chosen for activation or deactivation.

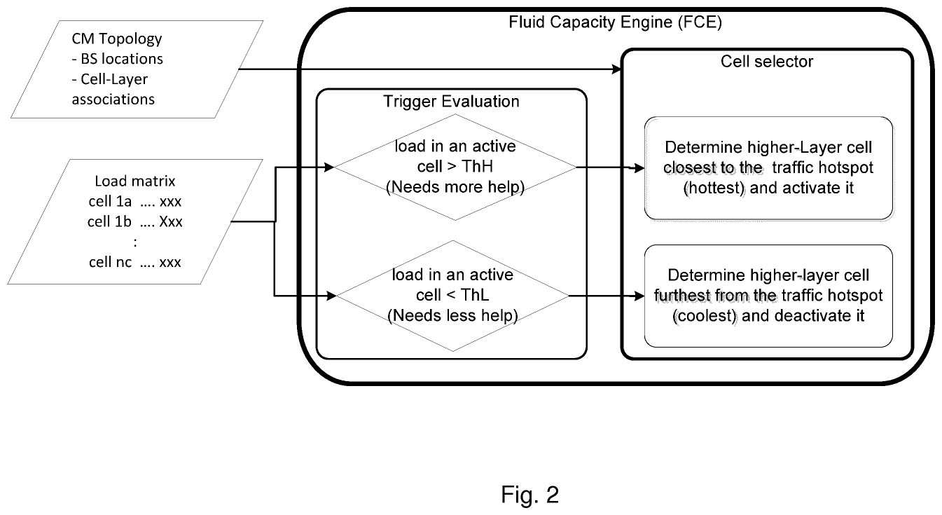

The invention proposes a Fluid Capacity Engine (FCE), as shown in FIG. 2. Using an analogy of heat flow for the propagation of load from users through coverage cells (e.g.

macro cells) and to the capacity cells (e.g. pico cells), the FCE uses triangulation of heat flow to determine a small cell that is best suited to take on load so as to maximize the network's spectral efficiency.

Assuming that load statistics are available for all cells of a PSG, a “trigger evaluation” module evaluates the load from the different cells to determine if there is need for deactivating some cells. By looking at load from multiple cells, it can trigger cell deactivation even if no single cell has very low load. All that is required is that there are a number of neighbor cells who together have reduced load that if one or more are deactivated, the remaining cells would handle the prevailing load. Conversely, the trigger evaluation module also evaluates if the load in a number of cells has increased that extra capacity is required. Cell reactivation is triggered even if no single cell has extremely high load.

Following the triggers, the cell selection module chooses the appropriate candidate cells to deactivate or reactivate. The logical reasoning is that UEs act as primary heat sources that induce an amount of heat at the coverage cell (e.g. macro cell). The coverage cell then acts as a secondary heat source towards the capacity cells (e.g. pico cell). Consequently, the selector does not need to directly consider UE locations since the effect of their heat is deducible from the secondary heat sources. Then, using CM information such as the Base station (BS) locations, their azimuths, and information about membership of the different cells to different layers (coverage vs. capacity), the cell selector considers the heat induced to each of the capacity cells and selects the capacity cell with the lowest induced heat for deactivation and the capacity cell with the highest induced heat for reactivation, respectively.

The cell activation/deactivation order may be derived using elliptical and/or circle geometry applying the different cells' locations, and in consideration of the generic propagation characteristics and instantaneous load of the cells as described in the implementation.

The FCE assumes availability of location data for all BSs of a PSG into which BSs are grouped. It selects the cells which are required to be active in order to carry the load in the respective PSGs. According to some embodiments of the invention, the PSGs and their respective loads are defined as follows:
1. Selection of Power Saving Groups (PSGs): Reference cells are those cells that offer full coverage in the considered area (be it macro cells or otherwise). A PSG is then defined per reference cell j, to be the list of all the neighbor cells to cell j, that are themselves not reference cells. Then, for any group, all group members that are not reference cells are considered as helpers to the reference cell and are candidates for deactivation (and reactivation). A helper cell may belong to one or more PSGs, while a reference cell belongs to only one PSG. The coverage area of the helper cells typically overlaps substantially with that of the reference cell. E.g., the helper cell's coverage area may be covered to at least 25%, preferably to at least 50%, more preferably to at least 75%, and most preferably to 100% by the coverage area of the reference cell.
2. PSG load and FCE triggering: According to some embodiments of the invention, the load in all cells of a PSG is considered to trigger selection of cells for (de)activation by the FCE. Three such examples are as follows:
   a. Considering all active cells of the PSG, a weighted average (or sum) of the loads may be considered. For example, all cells of the PSG may have the same weight. In some embodiments, the weight for the load of the reference cell may be higher than that for some or all of the helper cells. In some embodiments, the load of the reference cell might not be considered at all (weight=0), or it may be considered as an additional restriction such that it is considered if the reference cell can carry the additional load if one of the helper cells is deactivated. Cell selection by the fluid capacity engine (FCE) is activated if the weighted average of the loads in the cells of the considered network scope (one or more PSGs) increases above a threshold ThH, or reduces below a threshold ThL.
   b. In another example, the activation decision is based on the reference cell load as an indication of group load. The assumption here is that helper cells apply admission and congestion control solutions which ensure that they always push away their extra load towards the reference cell. If the reference cell's load reduces (to below some threshold), more cells are deactivated since the reference is considered to be in a position to carry more traffic, i.e. does not need as much help. Conversely, the reverse is done if the reference cell's load increases (above some threshold). So, for a network scope, if load in a reference cell exceeds a threshold ThH, or reduces below a threshold ThL, the cell selection by the fluid capacity engine (FCE) is activated.
   c. In still another example, the trigger evaluation may consider the maximum load of all loads of the helper cells of one or more PSGs. If the maximum load is less than an upper threshold, the total load seems to be sufficiently low such that one or more helper cells may be selected by the FCE for deactivation. Conversely, the trigger evaluation may consider the minimum load of all loads of the helper cells of one or more PSGs. If the minimum load is larger than a lower threshold, the total load seems to be high such that one or more helper cells may be selected by the FCE for activation. These examples may be considered as particular cases where the weight for the load of the reference cell is 0.

The different examples may be based on different implementations, or some or all of them may be implemented and the actually used option may be configured, e.g. by an OAM command or when switching on the FCE.

Some embodiments of the invention may consider the instantaneous loads of the cells. However, in order to avoid toggling of the activation states and spread the signaling of the load over time, average or aggregated loads may be considered, wherein the averaging or aggregation times of different cells may be slightly shifted between different cells. For example, each of the helper cells and the reference cell may report the load averaged over 10 or 15 minutes, and the starting points of the cell specific averaging intervals may be shifted by up to 5 or 7.5 minutes, respectively.

Appropriate values of the thresholds ThL and/or ThH may be predetermined subjectively and/or based on experience from the operation of the network. In some embodiments, the thresholds may be adapted if it turns out that they are not appropriate (e.g. because helper cells are activated too late or deactivated too early such that there are congestion problems, or because helper cells are activated too early or deactivated too late such that there is unnecessary energy consumption).

In some embodiments of the invention, cell selection by the cell selector of the FCE is triggered periodically or after lapse of a certain period of time after some other event. Such events could be e.g. a last activation or deactivation of a helper cell, and/or the termination of a last cell selection calculation even if it was decided in this selection process not to (de)activate any cell.

Some embodiments may combine some or all of the trigger events by a logical AND. Some embodiments may combine some or all of the trigger events by a logical OR.

Switch-On Switch-Off Order:

Candidates for deactivation and reactivation, respectively, are selected based on their expected spectral efficiency, i.e. in order to retain those helpers that result in the highest spectral efficiency for the network/area. Substantially, cells are activated starting with those small cells which are, in radio terms, closest to the edge of the reference cell. A user nearest such a small cell would have the worst spectral efficiency from the reference cell. So if that user is transferred to the small cell more resources are availed at the reference cell. Deactivation then goes in the reverse direction starting with the small cells that are closest to the reference. For the deactivation, the load of the activated helper cells may be additionally taken into account.

The FCE comprises the cell selector. According to some embodiments of the invention, it selects one or more cells based on a triangulation of heat floor. Consider the load at a reference cell j of a PSG as an amount of secondary heat generated at that cell's edge, with the mobile devices in the cell as the primary distributed heat sources. Maximum load (heat) is generated at the edge of the cell, i.e. maximum load is transferred from cell j if a new small cell (helper cell) i is activated at or closer to the edge of cell j.

### Variant 1: Singe Reference Cell

Consider a reference cell j with cell range Rⱼ and having a set of helper cells i as shown in FIG. 3. FIG. 3 shows an antenna site of a reference cell j as a solid triangle, the reference cell as an ellipse whereof the largest axis indicates its direction, and plural helper cells s1 to s7 indicated as white circles, wherein each helper cell is at least partly covered by the reference cell. That is, a PSG consists of the reference cell j and the helper cells i (i=1, 2, 3 . . . ). The cell range is indicated as a distance from the antenna site of the reference cell to the most remote border of the reference cell, which is, in this case, in the direction of the cell. The cell range may be obtained using state of the art techniques from the physical parameters of the reference cell like transmit power and antenna gain as well as the propagation conditions.

In some cases, as shown in FIG. 3, propagation conditions such as obstacles may be disregarded. The border may be defined such that the attenuation of the signal in the cell is not more than a predefined level.

Cell Activation:

For small cell i, given distance dᵢⱼ to each cell j with load ρⱼ, induced heat (from hotspot near j), is

$${h}_{ij} = \{ \begin{matrix}{ρ}_{j} \cdot {[ \frac{{d}_{ij}}{cos ( {α}^{τ} )} ]}^{r} & , \frac{{d}_{ij}}{cos ( {α}^{τ} )} < {R}_{j} \\ {ρ}_{j} \cdot {[ \frac{{d}_{ij}}{cos ( {α}^{τ} )} ]}^{r} \cdot [ 1 - {[ \frac{\frac{{d}_{ij}}{cos ( {α}^{τ} )} - {R}_{j}}{{R}_{j}} ]}^{1 \text{/} r} ] & , \frac{{d}_{ij}}{cos ( {α}^{τ} )} > {R}_{j}\end{matrix} ,$$

ρᵢ is load at j; dᵢⱼ is the distance between i and j; Rⱼ is the radius or range of cell j and describes the maximum coverage distance of that cell. α is angle between the direction of cell j and the line between cells j and I. Typically, the direction of cell j is the direction in which the cell has its maximum coverage distance. For an Omni-directional cell, α=0 since the line between the two cells lies along the path of maximum gain.

r is a coefficient of heat flow with an assumed default value of 1. Extra studies may reveal that other values of r are applicable in some cases. Note that the heat in this case is the cell load, measured either in absolute carried terms, e.g., in Mbps or in used cell resources such LTE Physical Resource Blocks.

τ is the beam width factor to account for how much, for a given distance d, the received signal changes as a function of the antenna's beam width; For example, τ=60°:0.3; 90°:0.45; 120°:0.5; omni:1

FCE activates the helper cell with the highest heat transfer (i.e. highest hᵢⱼ), i.e.

$$Candidate = arg {max}_{i} {h}_{ij} \qquad ( 2 )$$

Cell Deactivation:

According to the state of the art, a cell is deactivated if its load reduces below a threshold T_{Lmin}. But typically, the load gradually reduces concurrently among all cells—i.e., it is possible that in each of n cells, load>T_{Lmin} but with a total load in all n cells that is less than m*T_{Lmax:} m<n. T_{Lmax} indicates an upper threshold for the load of each cell. Hence the above condition means that the traffic which is distributed over n cells (each of which having a load larger than T_{Lmin} which is a threshold for individual deactivation) may be carried by a smaller number m of cells without overloading these m cells (load<T_{Lmax}). Both T_{Lmax} and T_{Lmin} may be predefined and T_{Lmax}>T_{Lmin}. T_{Lmax} and T_{Lmin} may be the same for all cells under consideration, or they may be different for some or all of the cells. In the latter case, the above products are to be replaced by corresponding sums over all cells under consideration. Therefore, according to some embodiments of the invention, cells may be deactivated even before their individual load is less than T_{Lmin}. Some example trigger conditions are discussed hereinabove.

According to some embodiments of the invention, cells closest to the reference cell (e.g. macro cell) may be deactivated. Here, the term “closest” may mean closest in the geographical sense, or closest taking into account radio propagation conditions. I.e., if one of the above trigger conditions is fulfilled, one or more helper cells closest to the reference cell are deactivated. Preferably, it is taken care that the combined induced heat due to the deactivation of one or more helper cells at the reference cell maintains the load of the reference cell below a threshold T_{Mhigh}. Note that small cell users who are moved to reference cells through the above process typically will be served well by the reference cell because they are close to the reference cell.

Assuming reference cell j, for small cell i with load ρᵢ, distance dᵢⱼ to cell j and angle α to j's bore sight (LOS path), hⱼᵢ the induced heat at j (by load near i) is,

$${h}_{ji} = \{ \begin{matrix}{ρ}_{i} \cdot {[ \frac{{d}_{ij}}{{cos}^{τ} ( α )} ]}^{r} & , \frac{{d}_{ij}}{{cos}^{τ} ( α )} < {R}_{j} \\ {ρ}_{i} \cdot {[ \frac{{d}_{ij}}{{cos}^{τ} ( α )} ]}^{r} \cdot [ 1 - {[ \frac{\frac{{d}_{ij}}{{cos}^{τ} ( α )} - {R}_{j}}{{R}_{j}} ]}^{1 \text{/} r} ] & , \frac{{d}_{ij}}{{cos}^{τ} ( α )} > {R}_{j}\end{matrix} \qquad ( 3 )$$

where, as defined previously, r is coefficient of flow, with a default value of 1. The FCE deactivates all helper cells (e.g. picos) with the lowest induced heat. In addition, it may preferably take into account that the expected total load of the reference cell does not exceed its maximum load. If the expected total load is higher than the maximum load, the cell selector may prohibit the deactivation of one or more the candidates for deactivation such that the expected total load of the reference cell is still less than the maximum load.

That is, according to some embodiments of the invention, FCE deactivates the helper cell with the lowest induced heat (i.e. lowest hᵢ) i.e.

$$Candidate = arg {min}_{i} {h}_{ji} \qquad ( 4 )$$

### Variant 2: Multiple Reference Cells

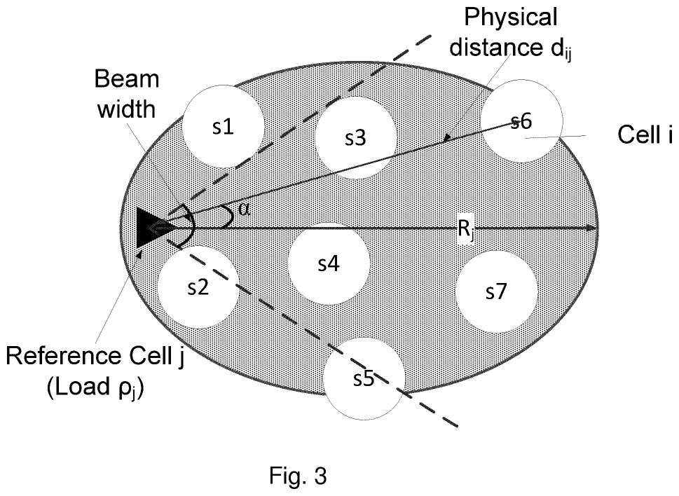

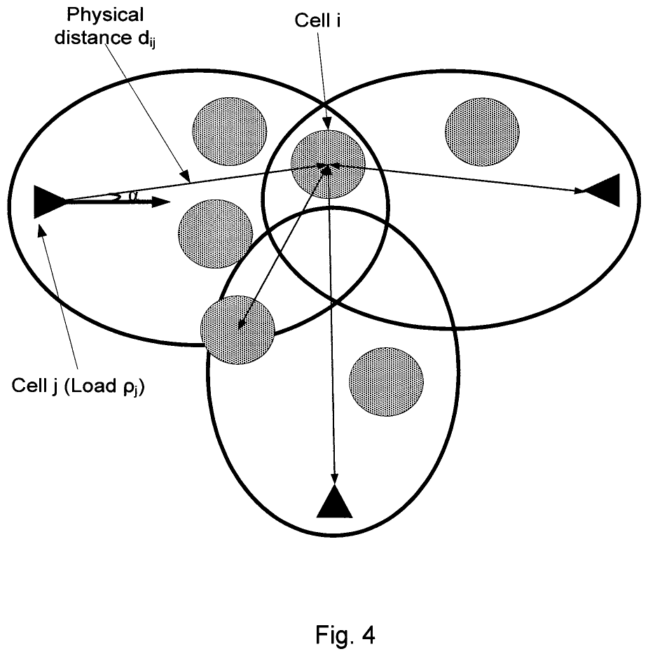

In some embodiments of the invention, plural reference cells may be considered simultaneously. When considering multiple reference cells, as shown in FIG. 4, the FCE determines the helper cell that will assist the reference cells as much as possible. i.e., it selects the helper cells under consideration of the combined transferred load from/to the reference cells.

FIG. 4 corresponds to FIG. 3 but shows plural partly overlapping reference cells (ellipses with solid triangles indicating the respective antenna sites) and plural helper cells (dotted circles) distributed among the plural reference cells.

Cell Activation:

In some embodiments, FCE uses the ranking equation (1) but, for each helper cell i, it aggregates the induced heat hᵢⱼ from each of the reference cells j. It then activates one or more helper cells with the highest total transferred heat (load) (i.e. highest hᵢ), i.e.

$$Candidate = arg {max}_{i} {\sum }_{∀ j} {h}_{ij} \qquad ( 5 )$$

Cell Deactivation:

According to some embodiments of the invention, FCE uses the deactivation ranking of equation (2) but, for each helper cell i, it aggregates the induced heat hⱼᵢ from each of the reference cells j. It then activates one or more helper cells with the lowest total transferred heat (load) (i.e. lowest hᵢ) i.e.,

$$Candidate = arg {min}_{i} {\sum }_{∀ j} {h}_{ji} \qquad ( 6 )$$

In some embodiments of the invention, only one of the option to determine the candidate cells considering one or plural reference cells (PSGs) is employed. In some embodiments, both of these options may be employed. In these embodiments, whether a selection is based on one or plural reference cells may be preconfigured (e.g. by an OAM command or at startup of the FCE). This decision may be different for different parts of the network. For example, if the reference cells substantially overlap, as shown in FIG. 4, it might be favorable to consider plural reference cells simultaneously, while, if the reference cells hardly do overlap, it might be favorable to consider a single cell only. Also, the effort for determining the candidate cells, which increases as the number of considered reference cells increases, may be a limiting factor for selecting the number of reference cells to be considered when selecting one or more candidate cells for (de)activation.

In some embodiments of the invention, only one helper cell is selected for (de)activation at a time. In some embodiments, one or more helper cells may be selected for (de)activation. E.g., in cell deactivation, FCE may select as many cells as possible such that the expected load of the reference cell is still below its maximum load. Correspondingly, in cell activation, FCE may select as many cells as needed to reduce the expected load of the reference cell below a certain limit (which may be less than the maximum load in order to allow for some hysteresis). If plural cells are selected, FCE may select them according to the sequence of total transferred heats obtained by formulas (5) and (6), respectively.

In some embodiments of the invention, the dynamic (instantaneous or averaged (aggregated)) load in the cells may not be considered (i.e., by taking ρᵢ=ρⱼ=1). Thus, the solutions in variants 1 and 2 change into static versions that can be applied at network planning time. In that case, the obtained ordering of the cells can be used as a fixed sequence according to which cells are (de)activated. Then, during operations the order of that sequence is used at all times when a cell selection is triggered.

Note that, from a point of energy savings and network service, such a static solution might not be optimal at all times since it does not consider the prevailing load conditions in the different cells. In particular, when deactivating, it might be preferred to combine both the location of the small cells and the instantaneous traffic they are carrying. It may be not optimal to deactivate a cell that is actually carrying traffic when there is another one (a cell closer to the reference cell) that is not carrying as much traffic.

On the other hand, the static solution reduces complexity at run-time and may also reduce the computational effort. Therefore, in particular if one of these criteria is limiting, the static solution may be favorable. For example, in some embodiments, FCE may switch between the static solution and the dynamic solution depending on the available processing capacity at FCE. In some embodiments of the invention, only one of the dynamic and the static solution may be employed or configured (e.g. by OAM command or at start time of FCE).

For the network in FIG. 3, assuming that instantaneous load is neglected (considered to be equal for all helper cells) so as to generate a static solution, a potential order of cells for activation will be: s6÷s5→s7→s1→s3→s4→s2. The reverse order may be followed for deactivation, i.e., deactivate in the order s2→s4→s3→s1→s7→s5→s6. Note that although s7 is further away from the antenna site of the reference cell than s5, it is possible, owing to the angle of s5 from the boresight (direction of the reference cell), that activating s5 results in higher spectral efficiency compared to s7 because a user near s7 will have a higher SINR from the reference cell.

An ESM (such as a FCE) of some embodiments of the invention may be employed as a centralized or a distributed ESM solution (from a network point of view). In the centralized solution, the allocation of cells to different layers could be configured once into a database that is used by the ESM. In a distributed solution, the same database, ESM may be employed in some or all of the reference cells or a control entity of them. In these cases, the NR table available in the base station may be extended such that the neighbors are marked as either reference cells or helper cells.

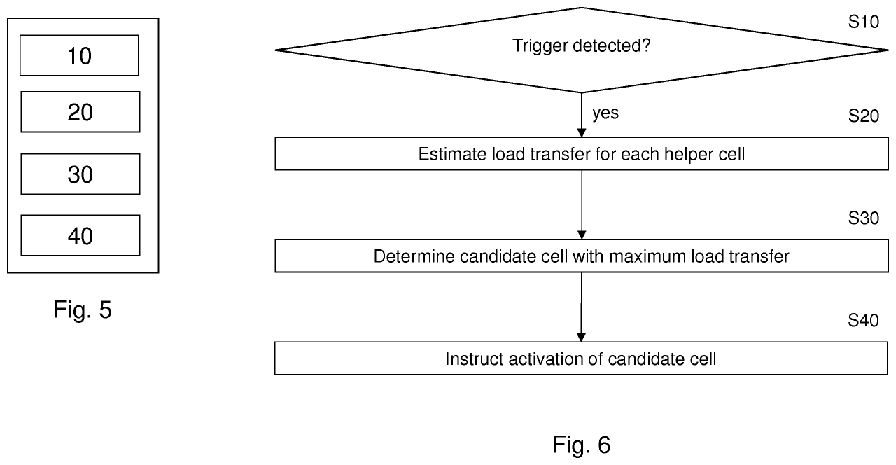

FIG. 5 shows an apparatus according to an example embodiment of the invention. The apparatus may be a ESM such as an FCE, or an element thereof. FIG. 6 shows a method according to an example embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises trigger detecting means 10, load transfer estimating means 20, candidate determining means 30, and instructing means 40. The trigger detecting means 10, load transfer estimating means 20, candidate determining means 30, and instructing means 40 may be an trigger detecting circuitry, load transfer estimating circuitry, candidate determining circuitry, and instructing circuitry, respectively.

The trigger detecting means 10 detects if a trigger is present (i.e., a trigger condition fulfilled) (S10). Some example triggers for activating a helper cell are described hereinabove.

If the trigger is detected (S10=“yes”), the load transfer estimating means 20 estimates, for each of one or more deactivated helper cells, a respective estimated transferred load (S20). According to the estimation, the respective estimated transferred load will be transferred from a reference cell to the respective helper cell if the respective helper cell will be activated. The one or more deactivated helper cells belong to a power saving group consisting of the reference cell and one or more helper cells including the deactivated helper cells.

The candidate determining means 30 determines a candidate cell among the deactivated helper cells (S30). The determination is made such that the estimated transferred load of the candidate cell is maximum among the estimated transferred loads.

The instructing means 40 instructs activating of the candidate cell (S40).

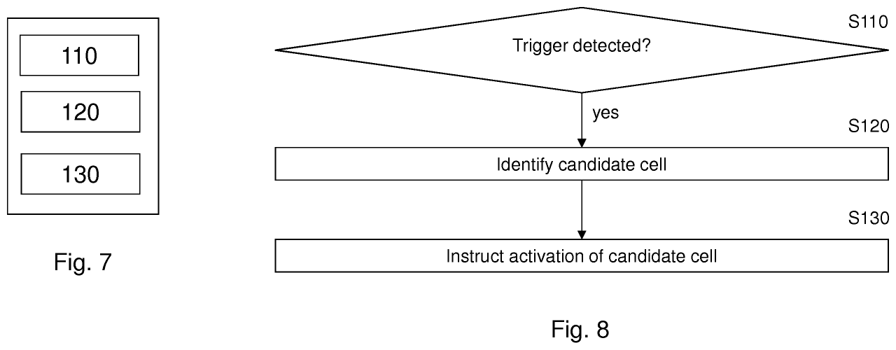

FIG. 7 shows an apparatus according to an example embodiment of the invention. The apparatus may be a ESM such as an FCE, or an element thereof. FIG. 8 shows a method according to an example embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises trigger detecting means 110, identifying means 120, and instructing means 130. The trigger detecting means 110, identifying means 120, and instructing means 130 may be a trigger detecting circuitry, identifying circuitry, and instructing circuitry, respectively.

The trigger detecting means 110 detects if a trigger is present (i.e., if a trigger condition is fulfilled) (S110). The trigger comprises at least one of
a combined load is higher than a predefined upper combined load threshold; and
a minimum of loads of activated helper cells of the power saving group is larger than a predefined lower minimum threshold.

The combined load is obtained by summing respective weighted loads of a reference cell associated to a power saving group and activated helper cells of the power saving group. Each of the weighted loads is obtained by multiplying a load of the respective one of the reference cell and the activated helper cells with a respective predefined weight. Respective weights for at least two of the cells of the power saving group are larger than 0.

If the trigger is detected (S110=“yes”), the identifying means 120 identifies a candidate cell (S120). For example, the identifying means may determine a candidate cell such that spectral efficiency in the PSG is maximized while the capacity demand is fulfilled.

The instructing means 130 instructs activating of the candidate cell (S130).

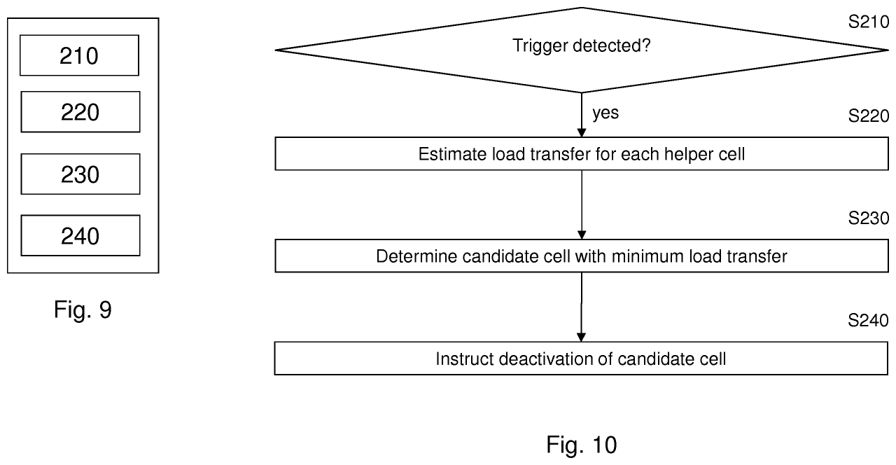

FIG. 9 shows an apparatus according to an example embodiment of the invention. The apparatus may be a ESM such as an FCE, or an element thereof. FIG. 10 shows a method according to an example embodiment of the invention. The apparatus according to FIG. 9 may perform the method of FIG. 10 but is not limited to this method. The method of FIG. 10 may be performed by the apparatus of FIG. 9 but is not limited to being performed by this apparatus.

The apparatus comprises trigger detecting means 210, load transfer estimating means 220, candidate determining means 230, and instructing means 240. The trigger detecting means 210, load transfer estimating means 220, candidate determining means 230, and instructing means 240 may be an trigger detecting circuitry, load transfer estimating circuitry, candidate determining circuitry, and instructing circuitry, respectively.

The trigger detecting means 210 detects if a trigger is present (i.e., a trigger condition fulfilled) (S210). Some example triggers for deactivating a helper cell are described hereinabove.

If the trigger is detected (S210=“yes”), the load transfer estimating means 220 estimates, for each of one or more activated helper cells, a respective estimated transferred load (S220). According to the estimation, the respective estimated transferred load will be transferred to a reference cell from the respective helper cell if the respective helper cell will be deactivated. The one or more activated helper cells belong to a power saving group consisting of the reference cell and one or more helper cells including the activated helper cells.

The candidate determining means 230 determines a candidate cell among the activated helper cells (S230). The determination is made such that the estimated transferred load of the candidate cell is minimum among the estimated transferred loads.

The instructing means 240 instructs deactivating of the candidate cell (S240).

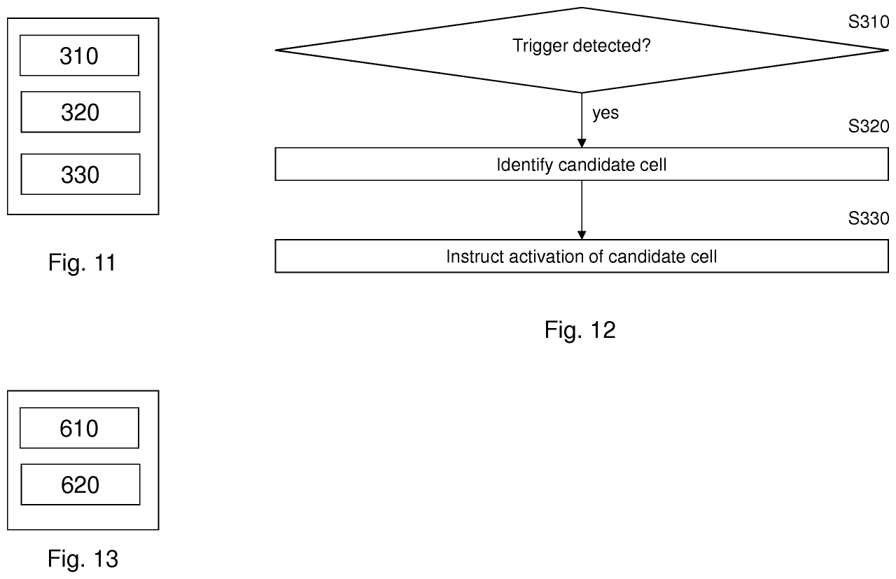

FIG. 11 shows an apparatus according to an example embodiment of the invention. The apparatus may be a ESM such as an FCE, or an element thereof. FIG. 12 shows a method according to an example embodiment of the invention. The apparatus according to FIG. 11 may perform the method of FIG. 12 but is not limited to this method. The method of FIG. 12 may be performed by the apparatus of FIG. 11 but is not limited to being performed by this apparatus.

The apparatus comprises trigger detecting means 310, identifying means 320, and instructing means 330. The trigger detecting means 310, identifying means 320, and instructing means 330 may be a trigger detecting circuitry, identifying circuitry, and instructing circuitry, respectively.

The trigger detecting means 310 detects if a trigger is present (i.e., if a trigger condition is fulfilled) (S310). The trigger comprises at least one of
a combined load is lower than a predefined lower combined load threshold; and
   a maximum load of loads of activated helper cells of the power saving group is larger than a predefined upper maximum threshold.

The combined load is obtained by summing respective weighted loads of a reference cell associated to a power saving group and activated helper cells of the power saving group. Each of the weighted loads is obtained by multiplying a load of the respective one of the reference cell and the activated helper cells with a respective predefined weight. Respective weights for at least two of the cells of the power saving group are larger than 0.

If the trigger is detected (S310=“yes”), the identifying means 320 identifies a candidate cell (S320). For example, the identifying means may determine a candidate cell such that spectral efficiency in the PSG is maximized while the capacity demand is fulfilled.

The instructing means 330 instructs activating of the candidate cell (S330).

FIG. 13 shows an apparatus according to an example embodiment of the invention. The apparatus comprises at least one processor 610, at least one memory 620 including computer program code, and the at least one processor 610, with the at least one memory 620 and the computer program code, being arranged to cause the apparatus to at least perform at least one of the methods according to FIGS. 6, 8, 10, and 12 and related description.

Some embodiments of the invention may employ only one of the described mechanisms for selecting one or more cells for activating. Some embodiments of the invention may employ only one of the described mechanisms for selecting one or more cells for deactivating. Some embodiments of the invention may employ both one of the described mechanisms for selecting one or more cells for activating and one of the described mechanisms for selecting one or more cells for deactivating.

Embodiments of the invention may be employed in different radio technologies allowing an overlapping radio cells, such as 3G, 4G, 5G networks of 3GPP, or a WiFi network. The base stations may be those of the respective technology, such as NodeB or eNodeB or an access point. The control functions of the radio network may be fully or partly located in the base station (e.g. in an eNodeB) or in a separate control entity such as a radio network controller.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Embodiments of the invention may be employed fully or partly in the cloud, wherein a resource (e.g. processor, software, memory, network) for the respective task may be shared with other applications.

According to the above description, it should thus be apparent that example embodiments of the present invention provide, for example a control device for a radio network such as an ESM device, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques, means, entities, units, devices, or methods include, as non-limiting examples, implementations as hardware, software, firmware, special purpose circuits or logic, general purpose hardware or controller or other computing devices, a virtual machine, or some combination thereof.

It should be noted that the description of the embodiments is given by way of example only and that various modifications may be made without departing from the scope of the invention as defined by the appended claims.

1. An apparatus, comprising:
at least one processor; and
at least one memory including computer program code;
the at least one memory and the computer program code configured to, with the at least one processor, cause the apparatus to
detect a trigger;
estimate, for each of one or more deactivated helper cells, a respective estimated transferred load if the trigger is detected, wherein the respective estimated transferred load will be transferred from a reference cell to the respective helper cell if the respective helper cell will be activated, and the one or more deactivated helper cells belong to a power saving group comprising of the reference cell and one or more helper cells;
determine a candidate cell among the deactivated helper cells, wherein the estimated transferred load of the candidate cell is maximum among the estimated transferred loads; and
instruct activating of the candidate cell.

2. The apparatus according to claim 1, wherein the trigger comprises at least one of the following:
lapse of a predetermined time period;
a combined load is higher than a predefined upper combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and
a minimum load of the loads of the activated helper cells of the power saving group is larger than a predefined lower minimum threshold.

3. The apparatus according to claim 2, wherein the trigger comprises that the combined load is higher than the predefined upper combined load threshold and the predefined weights for all of the helper cells are 0.

4. The apparatus according to claim 1, wherein, for each of the deactivated helper cells, the estimated transferred load from the reference cell j to the respective deactivated helper cell i upon activation of the helper cell i is calculated according to a following formula:
$${h}_{ij} = \{ \begin{matrix}{ρ}_{j} \cdot {[ \frac{{d}_{ij}}{cos ( {α}^{τ} )} ]}^{r} & , \frac{{d}_{ij}}{cos ( {α}^{τ} )} < {R}_{j} \\ {ρ}_{j} \cdot {[ \frac{{d}_{ij}}{cos ( {α}^{τ} )} ]}^{r} \cdot [ 1 - {[ \frac{\frac{{d}_{ij}}{cos ( {α}^{τ} )} - {R}_{j}}{{R}_{j}} ]}^{1 \text{/} r} ] & , \frac{{d}_{ij}}{cos ( {α}^{τ} )} > {R}_{j}\end{matrix} ,$$
wherein
ρᵢ is a load of the reference cell j; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on a beam width of an antenna of the reference cell j.

5. The apparatus according to claim 1, wherein the at least one memory and the computer program code are further configured to
estimate, for each deactivated cell of plural power saving groups, a respective estimated transferred load per power saving group of the plural power saving groups, wherein each of the plural power saving groups is predefined, comprises a respective reference cell and respective one or more helper cells, and for all of the plural power saving groups the reference cells are different from each other;
add, for each of the deactivated cells of the plural power saving groups, the respective estimated transferred loads per power saving group in order to obtain a total estimated transferred load for the respective deactivated cell; and
determine the candidate cell such that the total estimated transferred load of the candidate cell is maximum among the total estimated transferred loads.

6. (canceled)

7. (canceled)

8. An apparatus, comprising:
at least one processor; and
at least one memory including computer program code;
the at least one memory and the computer program code configured to, with the at least one processor, cause the apparatus to
detect a trigger;
estimate, for each of one or more activated helper cells, a respective estimated transferred load if the trigger is detected, wherein the respective estimated transferred load will be transferred to a reference cell from the respective helper cell if the respective helper cell will be deactivated, and the one or more activated helper cells belong to a power saving group consisting of the reference cell and one or more helper cells;
determine a candidate cell among the activated helper cells, wherein the estimated transferred load of the candidate cell is minimum among the estimated transferred loads; and
instruct deactivating of the candidate cell.

9. The apparatus according to claim 8, wherein the trigger comprises at least one of the following:
lapse of a predetermined time period;
a combined load is lower than a predefined lower combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and
a maximum load of the loads of the activated helper cells of the power saving group is smaller than a predefined upper maximum threshold.

10. The apparatus according to claim 9, wherein the trigger comprises that the combined load is lower than the predefined lower combined load threshold and the predefined weights for all of the helper cells are 0.

11. The apparatus according to claim 8, wherein, for each of the activated helper cells, the estimated transferred load to the reference cell j from the respective activated helper cell i upon deactivation of the helper cell i is calculated according to a following formula:
$${h}_{ji} = \{ \begin{matrix}{ρ}_{i} \cdot {[ \frac{{d}_{ij}}{{cos}^{τ} ( α )} ]}^{r} & , \frac{{d}_{ij}}{{cos}^{τ} ( α )} < {R}_{j} \\ {ρ}_{i} \cdot {[ \frac{{d}_{ij}}{{cos}^{τ} ( α )} ]}^{r} \cdot [ 1 - {[ \frac{\frac{{d}_{ij}}{{cos}^{τ} ( α )} - {R}_{j}}{{R}_{j}} ]}^{1 \text{/} r} ] & , \frac{{d}_{ij}}{{cos}^{τ} ( α )} > {R}_{j}\end{matrix} ,$$
wherein
ρᵢ is a load of the helper cell i; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on beam width of an antenna of the reference cell j.

12. The apparatus according to claim 8, wherein the at least one memory and the computer program code are further configured to cause the apparatus at least to
estimate, for each activated cell of plural power saving groups, a respective estimated transferred load per power saving group of the plural power saving groups, wherein each of the plural power saving groups is predefined, comprises a respective reference cell and respective one or more helper cells, and for all of the plural power saving groups the reference cells are different from each other;
add, for each of the activated cells of the plural power saving groups, the respective estimated transferred loads per power saving group in order to obtain a total estimated transferred load for the respective activated cell; and
determine the candidate cell such that the total estimated transferred load of the candidate cell is minimum among the total estimated transferred loads.

13. (canceled)

14. (canceled)

15. A method, comprising:
detecting a trigger;
estimating, for each of one or more deactivated helper cells, a respective estimated transferred load if the trigger is detected, wherein the respective estimated transferred load will be transferred from a reference cell to the respective helper cell if the respective helper cell will be activated, and the one or more deactivated helper cells belong to a power saving group comprising of the reference cell and one or more helper cells;
determining determine a candidate cell among the deactivated helper cells, wherein the estimated transferred load of the candidate cell is maximum among the estimated transferred loads; and
instructing activating of the candidate cell.

16. The method according to claim 15, wherein the trigger comprises at least one of the following:
lapse of a predetermined time period;
a combined load is higher than a predefined upper combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and
a minimum load of the loads of the activated helper cells of the power saving group is larger than a predefined lower minimum threshold.

17. The method according to claim 16, wherein the trigger comprises that the combined load is higher than the predefined upper combined load threshold and the predefined weights for all of the helper cells are 0.

18. The method according to claim 15, wherein, for each of the deactivated helper cells, the estimated transferred load from the reference cell j to the respective deactivated helper cell i upon activation of the helper cell i is calculated according to a following formula:
$${h}_{ij} = \{ \begin{matrix}{ρ}_{j} \cdot {[ \frac{{d}_{ij}}{cos ( {α}^{τ} )} ]}^{r} & , \frac{{d}_{ij}}{cos ( {α}^{τ} )} < {R}_{j} \\ {ρ}_{j} \cdot {[ \frac{{d}_{ij}}{cos ( {α}^{τ} )} ]}^{r} \cdot [ 1 - {[ \frac{\frac{{d}_{ij}}{cos ( {α}^{τ} )} - {R}_{j}}{{R}_{j}} ]}^{1 \text{/} r} ] & , \frac{{d}_{ij}}{cos ( {α}^{τ} )} > {R}_{j}\end{matrix} ,$$
wherein
ρᵢ is a load of the reference cell j; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on a beam width of an antenna of the reference cell j.

19. The method according to claim 15, wherein
the estimating of the transferred load comprises estimating, for each deactivated cell of plural power saving groups, a respective estimated transferred load per power saving group of the plural power saving groups, wherein each of the plural power saving groups is predefined, comprises a respective reference cell and respective one or more helper cells, and for all of the plural power saving groups the reference cells are different from each other; and the method further comprises
adding, for each of the deactivated cells of the plural power saving groups, the respective estimated transferred loads per power saving group in order to obtain a total estimated transferred load for the respective deactivated cell; wherein
the candidate cell is determined such that the total estimated transferred load of the candidate cell is maximum among the total estimated transferred loads.

20. (canceled)

21. (canceled)

22. A method, comprising:
detecting a trigger;
estimating, for each of one or more activated helper cells, a respective estimated transferred load if the trigger is detected, wherein the respective estimated transferred load will be transferred to a reference cell from the respective helper cell if the respective helper cell will be deactivated, and the one or more activated helper cells belong to a power saving group comprises the reference cell and one or more helper cells;
determining a candidate cell among the activated helper cells, wherein the estimated transferred load of the candidate cell is minimum among the estimated transferred loads; and
instructing deactivating of the candidate cell.

23. The method according to claim 22, wherein the trigger comprises at least one of the following:
lapse of a predetermined time period;
a combined load is lower than a predefined lower combined load threshold, wherein the combined load is obtained by summing respective weighted loads of the reference cell and activated helper cells of the power saving group, each of the weighted loads is obtained by multiplying a load of the respective one of the reference cell and the activated helper cells with a respective predefined weight; and
a maximum load of the loads of the activated helper cells of the power saving group is smaller than a predefined upper maximum threshold.

24. The method according to claim 23, wherein the trigger comprises that the combined load is lower than the predefined lower combined load threshold and the predefined weights for all of the helper cells are 0.

25. The method according to claim 22, wherein, for each of the activated helper cells, the estimated transferred load to the reference cell j from the respective activated helper cell i upon deactivation of the helper cell i is calculated according to a following formula:
$${h}_{ji} = \{ \begin{matrix}{ρ}_{i} \cdot {[ \frac{{d}_{ij}}{{cos}^{τ} ( α )} ]}^{r} & , \frac{{d}_{ij}}{{cos}^{τ} ( α )} < {R}_{j} \\ {ρ}_{i} \cdot {[ \frac{{d}_{ij}}{{cos}^{τ} ( α )} ]}^{r} \cdot [ 1 - {[ \frac{\frac{{d}_{ij}}{{cos}^{τ} ( α )} - {R}_{j}}{{R}_{j}} ]}^{1 \text{/} r} ] & , \frac{{d}_{ij}}{{cos}^{τ} ( α )} > {R}_{j}\end{matrix} ,$$
wherein
ρᵢ is a load of the helper cell i; dᵢⱼ is a distance between the helper cell i and the reference cell j; Rⱼ is a radius or a range of the reference cell j describing a maximum coverage distance of the reference cell; α is an angle between a direction of the reference cell j and a line between the reference cell j and the helper cell i; r is a predefined coefficient; and τ is a beam width factor based on beam width of an antenna of the reference cell j.

26. The method according to claim 22, wherein
the estimating of the transferred load comprises estimating, for each activated cell of plural power saving groups, a respective estimated transferred load per power saving group of the plural power saving groups, wherein each of the plural power saving groups is predefined, comprises a respective reference cell and respective one or more helper cells, and for all of the plural power saving groups the reference cells are different from each other; and the method further comprises
adding, for each of the activated cells of the plural power saving groups, the respective estimated transferred loads per power saving group in order to obtain a total estimated transferred load for the respective activated cell; wherein
the candidate cell is determined such that the total estimated transferred load of the candidate cell is minimum among the total estimated transferred loads.

27. (canceled)

28. (canceled)

29. A computer program product embodied on a non-transitory computer-readable medium, said product comprising a set of instructions which, when executed on an apparatus, is configured to cause the apparatus to carry out the method according to claim 15.

30. (canceled)
